(19) United States
(12) Patent Application Publication
(10) Pub. No.: US 2026/0226924 A1
(43) Pub. Date: Aug. 6, 2026

(54) Apparatus

(71) Applicant: Hydac Technology GmbH, Sulzbach / Saar (DE)

(72) Inventors: John Otto, Spicheren (DE); Torsten Kusserow, Thörnich (DE); Yannik ZImmer, Wendel-Iloof (DE); Sven Daniel Mann, Günter (DE)

(73) Assignee: Hydac Technology GmbH, Sulzbach / Saar (DE)

(21) Appl. No.: 19/151,311

(22) PCT Filed: Jul. 12, 2024
(86) PCT No.: PCT/EP2024/069830

§ 371 Date: Jul. 26, 2025

(30) Foreign Application Priority Data
Aug. 7, 2023 (DE) 10 2023 003 257.3

(51) Int. Cl. F15B 21/044

(52) U.S. Cl. CPC F15B 21/044

(57) ABSTRACT

The disclosure relates to an apparatus for separating gases from fluids, such as air from hydraulic oil, comprising a container having at least two connection points for selectively supplying or discharging fluid with a guide device which enlarges the fluid path for a fluid flow between the connection points and changes the direction of the fluid flow.

### CROSS-REFERENCE TO RELATED APPLICATIONS

This application claims priority to German Patent Application DE 10 2023 003 257.3, filed on Aug. 7, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an apparatus for separating gases from fluids, such as air from hydraulic oil.

DE 10 2014 117 327 A1 discloses a steering system for a motor vehicle having a hydraulic cylinder, in which a piston is arranged that can move in the axial direction of the hydraulic cylinder, the hydraulic cylinder having first and second pressure chambers that are separated from one another by the piston, the hydraulic cylinder having a first stroke that can be used during operation of the steering system; a reversible hydraulic pump, which is connected to the first pressure chamber of the hydraulic cylinder by a first hydraulic line and to the second pressure chamber of the hydraulic cylinder by a second hydraulic line; an oil container for compensating the volume of the hydraulic cylinder; and a device for bleeding the steering system, the hydraulic cylinder comprising a second stroke lying outside the first effective stroke for bleeding the steering system, the device for bleeding the steering system being configured to fluidically connect the first pressure chamber of the hydraulic cylinder to the second pressure chamber of the hydraulic cylinder when the piston is positioned in a region of the second stroke of the hydraulic cylinder. The aim of the known solution is to improve a steering system with a “closed middle” such that this can be bled simply and reliably, the device for bleeding the steering system being active during the steering system filling operation. To this end, it is provided that the piston of the hydraulic cylinder can be positioned in a region that is specially provided for a bleeding mode of the steering system outside an effective stroke of the hydraulic cylinder for the respective steering movement. Only when the piston is in this position is the device released for bleeding the steering system.

### SUMMARY

A need exists to provide an improved apparatus for separating gases from fluids, such as air from hydraulic oil.

The need is addressed by the subject matter of the independent claim(s). Embodiments of the invention are described in the dependent claims, the following description, and the drawings.

### BRIEF DESCRIPTION OF THE DRAWINGS

FIG. 1 shows a longitudinal sectional view through an example apparatus in its entirety; and

FIG. 2 takes the form of a very simplified view of an example hydraulic circuit diagram showing the use of the apparatus according to FIG. 1 for a hydraulic braking system.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the apparatus for separating gases from fluids, such as air from hydraulic oil, comprises a container having at least two connection points for alternately supplying or discharging fluid with a guide device which enlarges the fluid path for a fluid flow between the connection points and changes the direction of the respective fluid flow.

A permanent, in particular automatic, gas separation from fluids is achieved in this manner, which does not provide for bleeding of a steering system only during the steering system filling operation, as is disclosed in the aforementioned prior art. In particular, this avoids any trapped air arising in the hydraulic oil no longer merely being pushed to and from during operation of the hydraulic apparatus but instead being actively discharged from the hydraulic oil. Accordingly, hydraulic circuits also no longer need to be very carefully vacuum-filled beforehand, which is theoretically already impossible, since in practice it is impossible to create an absolutely airless space.

As not only is the fluid path for the fluid flow in the container enlarged by means of the guide device, with the option for accordingly improved gas separation, this generally also causes a partial drop in pressure in the region in which the direction is reversed by deflection, which helps improve the removal of even finely dispersed air bubbles in the hydraulic oil. Furthermore, this also causes flow calming and turbulence, which favour the formation of air bubbles and thus prevent the further throughflow of dispersed air.

The guide device as a gas separation device or gas removal device is an integral part of the aforementioned container and forms, together with said container, a commercial construction unit such that the apparatus in its entirety can also be fitted retrospectively in existing fluid circuits in the form of a retrofit kit. As such, the container with the guide device as a separation device for gas is a substantially standardised component and complicated adaptations of hydraulic cylinders regarding the free stroke for the purpose of adjusting steering or for the purpose of carrying out bleeding are avoided.

In some embodiments, it is provided that the guide or separation device consists of at least two tubular parts, for example arranged concentrically in relation to one another, of which one inner tubular part is positioned in an outer tubular part and emerges with one of its free ends into one connection point and with its other free end into a deflection area, which is surrounded by the other tubular part, which is configured to be closed in the direction of the other connection point and creates a fluid-conveying connection between the deflection area and the inside of the container via a connecting point. Thanks to this concentric arrangement, a reliable spatial separation of the respective inflow side from the outflow side is achieved and due to the flow deflection and the flow calming via an associated jump in level, reliable gas separation from the respective fluid flow passing through the container is achieved.

For example, in this case, it is provided that the inner tubular part forms a guide body in the form of a hollow cylinder which penetrates the container at one fluid connection point and is fixed to said connection point. For example, in this case, it is also provided that the outer tubular part forms a sleeve body in the form of a hollow cylinder, which comprises a baffle plate on its closed side facing the other connection point and is sealed from the inner tubular part on its opposite open side and is fixed to the inner wall of the container and/or to the inner tubular part. For example, in this case, the deflection area is sealed from the inner tubular part, the connection between the deflection area and the inside of the container being provided at the level of the corresponding closure. While, accordingly, oil containing a considerable amount of air is still to be expected on the respective inflow side, as the throughflow of the fluid guide device increases in the direction of the respective outflow side, this leads to a reduction in the air content in the oil and thus to a considerable depletion of gas in the oil. In this manner, separation takes place virtually continuously and automatically during operation of the apparatus.

In some embodiments, it is provided that the container, the fluid connection points and the guide device are arranged concentrically in relation to their respective longitudinal axes, and that the guide device, starting from one fluid connection point in the direction of the other fluid connection point, viewed in the axial direction, ends approximately in the middle of, or below the middle line in the container. In this manner, a structurally simple design of the apparatus is obtained, which can thus be manufactured cost-effectively. It is also helpful if the container is configured to be rotationally symmetrical in relation to its longitudinal axis and in particular consists of a container, as is usual for diaphragm accumulators, which is composed of two housing halves in a pressure-tight manner and is generally produced in very large quantities in the form of mass production.

In this case, in a particularly beneficial manner, in both possible fluid flow directions through the container, a transport interruption of an otherwise direct fluid transport between the fluid connection points is brought about by means of the guide device with flow calming and flow deflection, with the result that a high separation rate of gas from fluid is achieved in both directions.

In some embodiments, it is provided that, during operation of said apparatus, fluid originating from the other fluid connection point, as the outflow side in this respect, is freed from gas by means of the separation or guide device, said gas building up in an upper region of the container, that, as it passes through the guide device, fluid that is visibly freed from gas is discharged to the fluid connection point serving as the outflow side, and that, as part of a flushing operation in which a reversal of the volume flow takes place between the inflow and outflow side, the gas collected in the container via the other connection point, which can for example be connected to a storage tank of a hydraulic system, passes into the environment via this storage tank. In this manner, an effective discharge of gas collected in the container is achieved as part of a container flushing operation. The corresponding gas separation from the fluid is also referred to in technical jargon as defoaming.

For example, the use of an apparatus as described above as part of a hydraulic braking system that for example needs to be bled continuously is provided, where the corresponding bleeding takes place automatically. Even if the hydraulic braking system is not used for longer periods, effective bleeding accordingly takes place automatically from the outset.

The apparatus is discussed in greater detail below with reference to further embodiments according to the FIGS. The FIGS. are schematic and not necessarily to scale.

Specific references to components, process steps, and other elements are not intended to be limiting. Further, it is understood that like parts bear the same or similar reference numerals when referring to alternate FIGS.

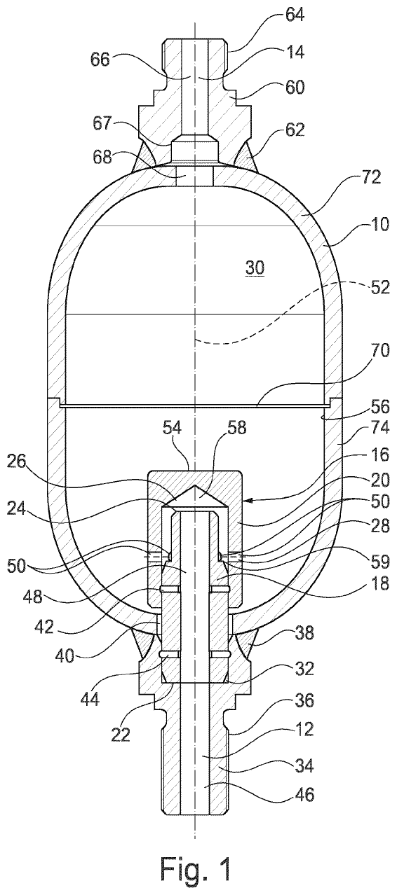

FIG. 1 shows the apparatus for separating gases from fluids, such as air from hydraulic oil, comprising a container 10 having at least two connection points 12, 14 for alternately supplying or discharging fluid. The apparatus in its entirety also comprises a guide device 16, which enlarges the possible fluid path for a fluid flow between the connection points 12, 14 and changes the direction of the respective fluid flow, which will be explained in further detail below.

The guide device 16 consists of two tubular parts 18, 20 arranged concentrically in relation to one another, of which one inner tubular part 18 is positioned in an outer tubular part 20 with a vertical orientation. The inner tubular part 18, as viewed on FIG. 1, emerges with its lower free end 22 into one connection point 12 and with its other upper free end 24 into a deflection area 26, which is surrounded by the outer tubular part 20, which is configured to be closed in the direction of the other connection point 14 otherwise creates a fluid-conveying connection between the deflection area 26 and the inside 30 of the container 10 via a connecting point 28.

The inner tubular part 18 is received with its lower free end 22 in a shoulder-like recess 32 in a connecting body 34, which has a male thread 36 in its free end region on the outer circumferential side and which is welded at the edges to a lower side of the container 10, for example in the form of a circumferential fillet weld 38, which may, for example, be applied by means of electron beam welding, laser welding or resistance pressure welding. Other welding methods may be used.

The inner tubular part 18 penetrates a through middle or container opening 40 on the lower side of the container 10 with a radial spacing. Furthermore, the inner tubular part 18 is fixed by means of two circlips 42, 44 opposite the inner side of the outer tubular part 20 or opposite the cylindrical inner side of the connecting body 34. The connecting body 34 surrounds a hollow cylindrical middle channel 46, forming one connection point 12, said middle channel retaining the same diameter and transitioning in a substantially step-free manner into a correspondingly formed middle channel 48 of the inner tubular part 18, which protrudes beyond the lower side of the container 10.

The aforementioned connecting point 28 in the outer tubular part 20 consists of individual through openings 50 in the form of holes which penetrate a cylinder wall of the outer tubular part 20 diametrically opposite a longitudinal axis 52 of the apparatus and create a fluid-conveying connection between the deflection area 26 and the inside 30 of the container 10. All through openings 50, of which the inner openings are partially covered by the inner tubular part 18 as illustrated, lie on a common middle plane that runs transversely in relation to the longitudinal axis 52 of the container 10 and have one and the same free cross-section.

Overall, the inner tubular part 18 forms a guide body in the form of a hollow cylinder which penetrates the container 10 at the fluid connection point 12 and is fixed in a stationary manner to the container 10. The outer tubular part 20, on the other hand, forms a sleeve body in the form of a hollow cylinder, which comprises a baffle plate 54 on its closed side facing the other connection point 14 and the outer tubular part 20 is sealed from the inner tubular part 18 on its opposite open side and is otherwise fixed to the outer wall of the inner tubular part 18 at the bottom, for example as part of applying a weld seam (not shown).

In an alternative, although likewise not illustrated, embodiment, it is also possible to fix the outer tubular part 20 at the bottom to the inner wall 56 of the container 10 in this region, wherein the middle opening 40, viewed from the underside of the outer tubular part 20, would then be covered in a fluid-tight manner by a weld seam, which is not shown, engaging in the remaining opening. The flat baffle plate 54 running transversely in relation to the longitudinal axis 52 has the benefit that, on impact with a fluid flow containing gas from the other connection point 14, the separation of gas from the fluid flow is improved, for example because this leads to a sharp deflection of the accordingly impacted fluid flow in the region of the baffle plate 54, with the gas being removed from the fluid.

The aforementioned deflection area 26 comprises a tapered inner cone 58, as shown on FIG. 1, which is arranged on the inner side of the outer tubular part 20, tapering conically in the direction of the baffle plate 54. Otherwise, the inner cone 58 engages in a roof-like manner over the upper free end 24 of the inner tubular part 18. Furthermore, the outer tubular part 20 with a constant diameter surrounds the inner tubular part 18 and the corresponding part of the deflection area emerges into the connecting point 28 in the form of the through openings, and specifically in a region of a stepped, shoulder-like widening 59 of the inner tubular part 18, which thereafter, with its outer circumference, comes into direct contact with the inner circumference of the outer tubular part 20. As such, the deflection area 26 is therefore delimited by the inner tubular part 18 and closed in the direction of one connection point 12. Furthermore, the fluid-conveying connection between the aforementioned deflection area 26 and the inside 30 of the container by means of the connecting point 28 substantially arises at the level of the corresponding closure between the outer tubular part 20 and the inner tubular part 18.

In addition, the container 10, as viewed on FIG. 1, has a further connecting body 60 on its upper end, said connecting body in turn being connected securely or in a fluid-tight manner respectively by means of a fillet weld 62 similar to the fillet weld 38 to the upper or outer side of the container 10. The further connecting body 60 also has a male connecting thread 64 on its free end and is penetrated in the centre by a middle channel 66, which emerges via a step-shaped widening 67 and a further circular middle opening 68 in the upper side of the container 10 into the inside 30 thereof.

The container 10, the fluid connection points 12, 14 and the guide device 16 are thus arranged concentrically in relation to the longitudinal axis 52 of the apparatus with their respective middle axes. The guide device 16 emerges along its baffle plate 54, originating from one fluid connection point 12 in the direction of the other fluid connection point 14, viewed in the axial direction, beneath a container middle line 70 in the container 10. The corresponding arrangement leads to particularly good gas separation performance, the baffle plate 54 also being able to emerge directly along the container middle line 70 in an alternative embodiment (not shown). The container 10 is configured to be rotationally symmetrical in relation to its longitudinal axis 52 and in particular consists of a container construction, as is usual for diaphragm accumulators, consisting of two housing halves 72, 74, which are connected to one another, in particular welded together, along the container middle line 70 in a pressure-tight manner. Corresponding diaphragm accumulator housings equipped with fibre windings, for example, are disclosed in DE 10 2008 062 837 A1. Diaphragm accumulators as such are generally manufactured in large quantities with the result that using them for the present guide or separation device is particularly cost-effective. Furthermore, thanks to the pressure vessel structure, this leads to a rigid, high-strength container wall construction.

The flow can pass through the container 10 in both directions, i.e. from the further connection point 14 in the direction of the first connection point 12 and vice versa, i.e. from one connection point 12 in the direction of the further connection point 14. In the aforementioned first case, the connection point 14 thus forms the so-called inflow side of the apparatus and the connection point 12 forms the outflow side. With the reverse flow situation, i.e. if the fluid flow direction is reversed, one connection point 12 then forms the inflow side and the further connection point 14 forms the outflow side. Accordingly, the flow can pass through the container 10 in both possible fluid flow directions, a transport interruption of an otherwise direct fluid transport between the two connection points 12, 14 being brought about by means of the guide device 16, the aforementioned transport interruption comprising both flow calming and flow deflection. Flow calming comes about as a result of extending the distances or the jump in level to transport the fluid caused by the connecting point 28, and the deflection area 26 and a deflection of the fluid flow through for example 180° as soon as fluid emerging from the inner tubular part 18, deflected by the inner cone 58 emerges into the further deflection area 26, in the case of another further right-angled deflection as soon as the fluid flow leaves the deflection area 26 via the through openings 50 of the connecting point 28 and emerges into the inside 30 of the container 10, which has a correspondingly larger volume. Comparable deflections take place in the other throughflow direction, i.e. originating from the connecting point 28 in the direction of the deflection area 26 of the outer tubular part 20 and also in the direction of the middle channel 48 of the inner tubular part 18.

During operation of the apparatus, the fluid containing gas supplied via the connection point 14 is therefore freed from gas by means of the guide device 16 with the result that the connection point 14 represents the inflow side of the guide device 16 and the connection point 12 represents the outflow side. In this case, the baffle plate 54 already contributes significantly to the gas separated from the fluid collecting or building up in the inside 30 of the container 10 on its upper side. Thanks to the guide device 16, the fluid arriving on the outflow side at the fluid connection point 12 is substantially free from gas. If, as part of a subsequent flushing operation, in which a reversal of the volume flow takes place between the inflow and outflow side such that one connection point 12 now forms the inflow side and the further connection point 14 forms the outflow side, the gas collected in the inside 30 of the container, which can also be in the form of foam in conjunction with the fluid, is discharged outwards via the fluid connection 14 and the gas thus discharged can be removed from the apparatus, as will be explained in further detail below. Starting from the baffle plate 54 of the outer tubular part 20, however, this constantly leads to a continuous gas separation the further the fluid flows downwards in the direction of the connecting point 28 with the through openings 50, and likewise in the reverse direction.

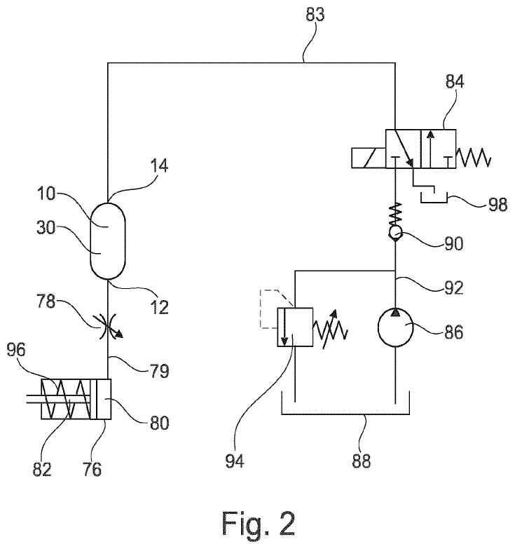

The use of the gas separation apparatus according to FIG. 1 is described below in further detail as part of a hydraulic braking system according to FIG. 2. In this case, FIG. 2 shows a spring-loaded hydraulic brake cylinder 76, which is connected in a fluid-conveying manner by a pipe 79 via an adjustable throttle or orifice 78 to one connection point 12, the corresponding fluid supply emerging on the piston side 80 of the brake cylinder 76, which is delimited by a piston rod unit 82, the spring-loaded piston rod unit 82 emerging with its rod part from the housing of the brake cylinder 76 in order to actuate a conventional mechanical brake. Furthermore, the upper or other connection point 14 of the container 10 is connected via a hydraulic connecting line 83 to a magnetically actuatable 3/2-way valve 84, which, in one valve position, creates a pressurised connection between a hydraulic pump 86 and this other connection point 14 of the container 10, the hydraulic pump 86 being supplied with fluid from a storage tank 88. The valve 84 assumes its right-hand switching position as shown in FIG. 2 to supply the brake cylinder 76 accordingly. A spring-loaded non-return valve 90 is connected between the hydraulic pump 86 and the valve 84, said non-return valve opening in the direction of the valve 84 and as such preventing an undesirable backflow of fluid in the direction of the hydraulic pump 86. The corresponding supply circuit 92 is protected in the conventional manner by means of a pressure limiting valve 94. The respective fluid line 83, 79 from valve 84 to the other connection point 14 and from the brake cylinder 76 via the throttle 78 to the first connection point 12, takes place via a conventional pipe, which is screwed to the connection point 14 or 12 respectively in the conventional manner with the male threads 64 and 36.

If the hydraulic pump 86 is switched on, the brake cylinder 76 is actuated and the piston rod unit 82 extends for the purpose of actuating the mechanical brake against the action of an energy accumulator in the form of the illustrated compression spring 96. Due to the guide or separation device 16, which is not illustrated in further detail in FIG. 2, the separated gas in the container 10 is collected on the upper side thereof in the direction of the other connection point 14, which can also take place in the form of a foam. If the valve 84 is then reversed and assumes its left-hand valve position as shown in FIG. 2, there is a fluid connection between the inside 30 of the container 10 and a tank 98, which can also be part of the storage tank 88. In the corresponding switching position of the valve 84, the brake cylinder 76 is no longer subject to brake pressure from the hydraulic pump 86 and, due to the action of the compression spring 96, reverts to its unactuated initial position, wherein fluid is ejected on the piston side 80 via the connection point 12 and the guide device 16 in the direction of the other connection point 14. In this process, the gas or foam respectively stored in the container 10 is ejected from the container 10 via the valve 84 in the direction of the tank 98, which maintains ambient pressure, with the result that the gas is thus permanently separated from the fluid in the tank 98. The brake system is then again available for a braking operation, wherein the correspondingly virtually automatic bleeding can take place even if the brake system is shut down for a longer period of time. Accordingly, this leads to gas separation by means of the separation and guide device 16 in the container 10 as soon as a braking operation is initiated in the described manner.

It is evident that the use of the gas separation device in braking systems is only given by way of an example and the described gas separation or removal device can manifestly also be used for other hydraulic systems.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. An apparatus for separating gases from fluids, such as air from hydraulic oil, comprising a container having at least two connection points for alternately supplying or discharging fluid with a guide device, which enlarges the fluid path for a fluid flow between the connection points and changes the direction of the respective fluid flow.

12. The apparatus of claim 11, wherein the guide device consists of at least two tubular parts, of which one inner tubular part is positioned in an outer tubular part and emerges with one of its free ends into one connection point and with its other free end into a deflection area, which is surrounded by the outer tubular part, which is configured to be closed in the direction of the other connection point and creates a fluid-conveying connection between the deflection area and the inside of the container via a connecting point.

13. The apparatus of claim 12, wherein the inner tubular part forms a guide body in the form of a hollow cylinder which penetrates the container at one connection point and is fixed to said connection point.

14. The apparatus of claim 12, wherein the outer tubular part forms a sleeve body in the form of a hollow cylinder, which comprises a baffle plate on its closed side facing the other connection point and is sealed from the inner tubular part on its opposite open side and is fixed to the inner wall of the container and/or to the inner tubular part.

15. The apparatus of claim 12, wherein the deflection area is delimited by the inner tubular part and wherein the connection between the deflection area and the inside of the container is provided at the level of the corresponding closure.

16. The apparatus of claim 11, wherein the container, the fluid connection points and the guide device are arranged concentrically in relation to their respective longitudinal axes, and wherein the guide device, starting from one fluid connection point in the direction of the other fluid connection point, viewed in the axial direction, ends approximately in the middle of, or below or above a middle line in the container.

17. The apparatus of claim 11, wherein the container is configured to be rotationally symmetrical in relation to its longitudinal axis.

18. The apparatus of claim 11, wherein, in both fluid flow directions through the container, a transport interruption of an otherwise direct fluid transport between the fluid connection points is brought about by the guide device with flow calming and flow deflection.

19. The apparatus of claim 11, wherein, during operation of said device, fluid originating from the other fluid connection point, as the outflow side in this respect, is freed from gas using the guide device, said gas building up in an upper region of the container, wherein, as it passes through the guide device, fluid that is visibly freed from gas is discharged to the fluid connection point serving as the outflow side, and wherein, as part of a flushing operation in which a reversal of the volume flow takes place between the inflow and outflow side, the gas collected in the container passes into the environment via the other connection point.

20. A method of using the apparatus of claim 11 as part of a hydraulic braking system that needs to be bled, comprising automatically bleeding the hydraulic braking system.

21. The apparatus of claim 12, wherein the at least two tubular parts are arranged concentrically in relation to one another.

22. The apparatus of claim 11, wherein the container is configured to be rotationally symmetrical in relation to its longitudinal axis and consists of a container, which is composed of two housing halves in a pressure-tight manner.

23. The apparatus of claim 11, wherein, during operation of said device, fluid originating from the other fluid connection point, as the outflow side in this respect, is freed from gas using the guide device, said gas building up in an upper region of the container, wherein, as it passes through the guide device, fluid that is visibly freed from gas is discharged to the fluid connection point serving as the outflow side, and wherein, as part of a flushing operation in which a reversal of the volume flow takes place between the inflow and outflow side, the gas collected in the container passes into the environment via the other connection point, which is connected to a storage tank of a hydraulic system.

24. The method of claim 20, wherein the guide device consists of at least two tubular parts, of which one inner tubular part is positioned in an outer tubular part and emerges with one of its free ends into one connection point and with its other free end into a deflection area, which is surrounded by the outer tubular part, which is configured to be closed in the direction of the other connection point and creates a fluid-conveying connection between the deflection area and the inside of the container via a connecting point.

25. The method of claim 20, wherein the inner tubular part forms a guide body in the form of a hollow cylinder which penetrates the container at one connection point and is fixed to said connection point.

26. The method of claim 20, wherein the outer tubular part forms a sleeve body in the form of a hollow cylinder, which comprises a baffle plate on its closed side facing the other connection point and is sealed from the inner tubular part on its opposite open side and is fixed to the inner wall of the container and/or to the inner tubular part.

27. The method of claim 20, wherein the deflection area is delimited by the inner tubular part and wherein the connection between the deflection area and the inside of the container is provided at the level of the corresponding closure.

28. The method of claim 20, wherein the container, the fluid connection points and the guide device are arranged concentrically in relation to their respective longitudinal axes, and wherein the guide device, starting from one fluid connection point in the direction of the other fluid connection point, viewed in the axial direction, ends approximately in the middle of, or below or above a middle line in the container.

29. The method of claim 20, wherein the container is configured to be rotationally symmetrical in relation to its longitudinal axis.

30. The method of claim 20, wherein, in both fluid flow directions through the container, a transport interruption of an otherwise direct fluid transport between the fluid connection points is brought about by the guide device with flow calming and flow deflection.
